(19) United States
(12) Patent Application Publication
(10) Pub. No.: US 2017/0157881 A1
(43) Pub. Date: Jun. 8, 2017

(54) METHOD AND DEVICE FOR PRODUCING FLEXIBLE PACKAGING PRODUCTS, MORE PARTICULARLY PACKAGING BAGS

(71) Applicant: CELLPACK AG, Villmergen (CH)

(72) Inventor: Martin KROPF, Münchenbuchsee (CH)

(21) Appl. No.: 15/324,238

(22) PCT Filed: Jul. 7, 2015
(86) PCT No.: PCT/EP2015/065452

§ 371 Date: Jan. 5, 2017

(30) Foreign Application Priority Data
Jul. 9, 2014 (EP) 14176376.3

(51) Int. Cl. B31B 1/00; B65H 20/20

(52) U.S. Cl. CPC B31B 19/02; B31B 19/16; B31B 19/64; B65H 20/20; B31B 2219/024; B31B 2219/145; B31B 2219/603; B31B 2221/107; B31B 2219/95

(57) ABSTRACT

The method serves for producing flexible packaging products, more particularly packaging bags, the packaging products being formed by welding together two film layers. In order to avoid imprecisions in the sequence of process steps, film sections (4) formed of film layers are separated from a film web (7a; 7b) and transferred to a transport device (1) where they are positively fixed at least at one edge by means of a fixing device (3). Then the film sections (4) are transported by means of the transport device (1) in a transport direction (5) to at least one welding station (12) while maintaining the positive fit, the film layers are welded together in the latter, and the film sections (4) are subsequently further transported while maintaining the positive fit.

The invention relates to a method for producing flexible packaging products according to the preamble of claim 1.

It is known to produce packaging products from web-shaped film stock that is delivered on rolls. The film material is either fed forward by roller pairs or by grippers that are arranged along a production facility and transport the film material in a stepwise manner. As a result, the film material has to meet requirements that are not dictated by the intended use and content of the packaging but mainly by the production process. The tensile forces applied to the film material require a material having a high tensile strength and a low elongation even at relatively high temperatures of up to 200 degrees centigrade or more as they are attained during welding. When fed forward by grippers, the film material also needs to have a certain stiffness as a portion of the web is always being pushed by the grippers. Therefore it is difficult to process thin films by means of these known methods.

The film material on the entire roll should exhibit a constant and preferably advantageous friction coefficient. Films that are too smooth will slip while being fed forward by the rollers or grippers, while films that are too rough tend to buckle in deflections. It is often attempted to obtain the desired sliding properties by the addition of lubricants that are applied to the films or incorporated into the film materials. These finishes are expensive, difficult to produce in a procedurally reliable manner, and the desired effect is lost during the storage period of the films due to the migration of the lubricant additives in the film layers. Moreover, the lubricants may potentially entail health risks for the consumers of thus packaged products. Another method for achieving desired sliding properties consists in structuring the film surface by mechanical embossing. Here also, the effect may decrease during the storage period as the mechanical embossing regresses. A printed film surface, which would be convenient per se and commercially advantageous, is barely used in the described tensile feed technique for the aforementioned reasons. Any printing provided on the film material may negatively influence the friction coefficient, and the printing might be damaged by the sliding transport of the film material.

Further disadvantages of these known production methods are that a considerable startup waste results when the film rolls are inserted or exchanged, inter alia because the film material on each new roll has its own sliding coefficient and the production facility needs to be adjusted to the new feed conditions. The associated variable elongation of the film webs causes imprecisions and waste. Moreover, the described methods require wider weld seams than would be necessary for the actually intended packaging use in order to compensate for imprecisions and variations in the guidance of the film material in the production facility. Accordingly, the varying positions of the material being fed forward produce waste due to the need of trimming the edges of the packaging products.

On the background of this prior art it is the object of the invention to suggest a method for producing flexible packaging products where the requirements regarding the film material are reduced to a minimum while simultaneously increasing the production reliability, minimizing material allowances for weld seams and edge trimmings, and minimizing waste.

According to the invention, this object is achieved by the features defined in the characterizing part of claim 1.

In particular, this inventive solution offers the advantage that by maintaining the positive fit after the film sections are delivered to the fixing devices, no further transfer of the film sections takes place and imprecisions during welding and possible further process steps are thus avoided. Furthermore, the film sections can be exposed to substantially higher accelerations without overstraining the film material than would be the case if the entire film web was moved as in the known state of the art.

Particular embodiments of the method are described in the dependent claims.

The invention also relates to a device according to the preamble of independent claim 5 which achieves the same object as the method according to claim 1.

Particular embodiments of the device are described in dependent claims 6 to 15.

Exemplary embodiments of the invention will be explained hereinafter with reference to the drawing showing

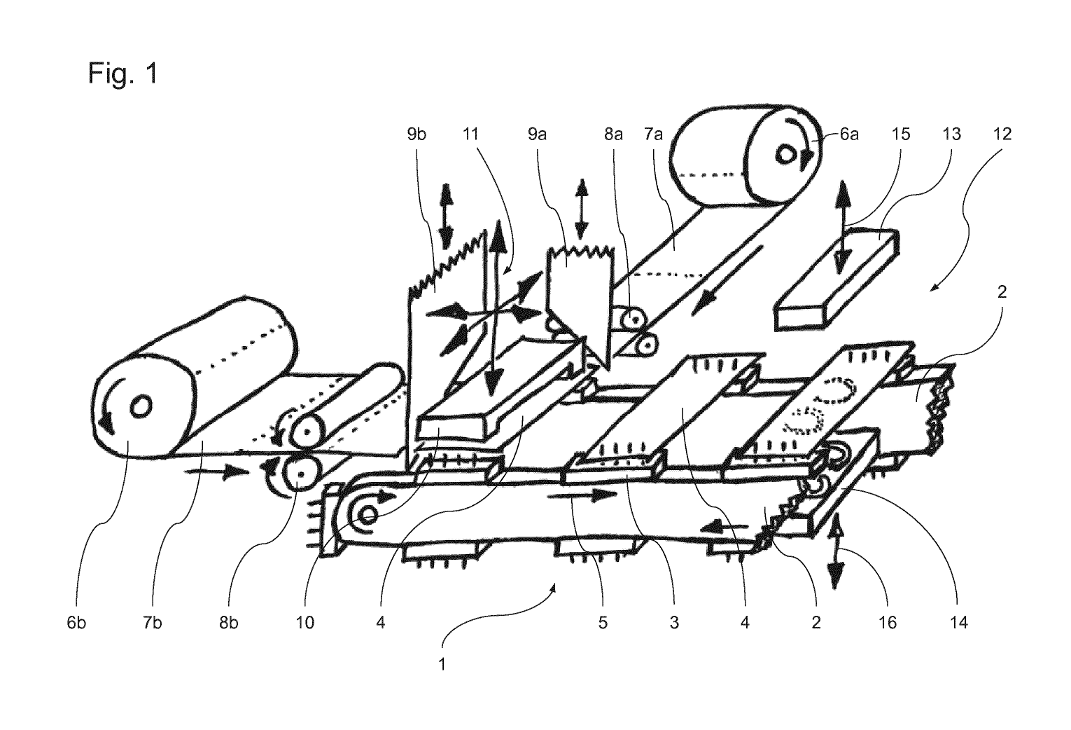

FIG. 1 a schematic perspective view of two embodiments of a device for implementing the method of the invention.

FIG. 1 shows a transport device 1 as the central element which in the illustrated exemplary embodiment consists of two parallel, synchronously drivable chain conveyors 2 which convey film sections 4 in a transport direction 5. Alternatively, a single chain conveyor 2 may be provided. Instead of chain conveyors, other transport devices might be provided, e.g. endless belts or cables or transport units driven by worm gears or by individual linear motors. Several fixing devices that will be discussed in more detail below serve for a positive retention of film sections 4 on chain conveyor 2. Two alternative arrangements for feeding film sections 4 to transport device 1 are illustrated in FIG. 1 where the respective reference numerals are denoted by letters a or b. Variant a denotes a supply of film sections 4 transversely to transport direction 5 while variant b denotes a supply of film sections 4 in the transport direction. Both variants a and b comprise respective supply rolls 6a and 6b from which respective film webs 7a and 7b are unwound. Respective roller pairs 8a and 8b serve for unwinding the film web from the supply roll and feeding the film web to a respective cutting devices 9a and 9b by which film sections 4 are cut from film web 7a or 7b, respectively.

In the present example, the respective supply roll 6a or 6b comprises two film layers that are either provided separately or formed by folding a single film web. Also, a film layer for producing bottom gusset bags may e.g. already be incorporated and connected to the other film webs e.g. by punctual tack welds. Alternatively, it is also possible to supply each film layer from a separate supply roll.

A positioning device 10 that is movable in all directions, as indicated by the group of arrows 11, serves for seizing the film sections 4 separated by the respective cutting device 9a or 9b and precisely positioning them on fixing devices 3. To seize film sections 4, the positioning device may be provided with vacuum grippers. The exact positioning is preferably achieved by means of marks that are printed onto the respective film web 7a or 7b or embossed thereon while possible imprecisions due to an elongation or contraction of the film web can be compensated by placing film sections 4 on fixing devices 3 in a corresponding manner. This constitutes a substantial advantage over the conventional production process on a web where imprecisions may add up.

In the present example, fixing devices 3 are designed as groups of needles which pierce the film sections 4. Non-represented hold-down devices ensure that film sections 4 are not detached from the needle groups during transport. In another embodiment, fixing devices 3 may comprise areas into which film sections 4 are impressed. These areas may e.g. be formed by conical or pyramidal elevations while the hold-down devices are provided with fitting recesses into which the corresponding areas of film sections 4 are forced by the aforementioned elevations. In the illustrated example, fixing devices 3 are arranged on parallel chain conveyors 2 such that a fixation of two parallel lateral edges of film sections 4 as seen in transport direction 5 results. Alternatively, it is also possible to provide chain conveyor(s) 2 with arms projecting at an angle and having fixing devices whereby respective edges of film sections 4 extending transversely to transport direction 5 are fixed.

Reference numeral 12 designates a welding station comprising an upper tool 13 and a lower tool 14 which are each movable at least vertically, as indicated by double arrows 15 and 16. For the sake of clarity, the illustration of the device ends on the right of welding station 12. The device may include further workstations, e.g. in the form of a further welding station, a cooling station, a cutting station, an assembly station, e.g. for weld-in parts, a test station or an unloading station for finished packaging bags as well as for edge trimmings that have remained in fixing devices 3.

Due to the fact that according to the invention, film sections are processed as opposed to the known production processes where a continuous web is processed, two additional edges are actually available for processing while maintaining the positive fit before the packaging products are detached, e.g. in order to affix weld-in parts such as pouring spouts.

List of reference numerals

| | |
|---|---|
| 1 | transport device |
| 2 | chain conveyor |
| 3 | fixing device |
| 4 | film section |
| 5 | transport direction |
| 6a | supply roll |
| 6b | supply roll |
| 7a | film web |
| 7b | film web |
| 8a | roller pair |
| 8b | roller pair |
| 9a | cutting device |
| 9b | cutting device |
| 10 | positioning device |
| 11 | arrows |
| 12 | welding station |
| 13 | upper tool |
| 14 | lower tool |
| 15 | double arrow |
| 16 | double arrow |
| 17 | |
| 18 | |
| 19 | |
| 20 | |
| 21 | |
| 22 | |
| 23 | |
| 24 | |
| 25 | |
| 26 | |
| 27 | |
| 28 | |
| 29 | |
| 30 | |
| 31 | |
| 32 | |
| 33 | |
| 34 | |
| 35 | |
| 36 | |
| 37 | |
| 38 | |
| 39 | |
| 40 | |

1. Method for producing flexible packaging products, more particularly packaging bags, where the packaging products are formed by welding together two film layers, wherein film sections formed of film layers are separated from a film web and delivered to a transport device where they are positively fixed at least at one edge by means of a fixing device, in that film sections are transported by means of the transport device in a transport direction to at least one welding station while maintaining the positive fit, the film layers are welded together in the latter, and the film sections are subsequently further transported while maintaining the positive fit.

2. Method according to claim 1, wherein the at least one edge is an edge extending in the transport direction.

3. Method according to claim 1, wherein the at least one edge is an edge extending at an angle to the transport direction.

4. Method according to claim 1, wherein the film sections are fixed at two opposite edges thereof.

5. Device for producing flexible packaging products, more particularly packaging bags, where the packaging products are formed by welding together two film layers, wherein the device comprises a cutting device for separating film sections formed of film layers from a film web and a positioning device for transferring the film sections to a transport device equipped with fixing devices, the fixing devices being movable along with the transport device and configured for positively fixing the film sections, and the device comprises at least one welding station for welding together the film layers.

6. Device according to claim 5, wherein the device comprises at least a further welding station.

7. Device according to claim 5, wherein the device includes at least a cooling station.

8. Device according to claim 5, wherein the device includes at least a cutting station for cutting the film sections.

9. Device according to claim 5, wherein the device includes at least an assembly station for providing the packaging products with further parts such as weld-in parts.

10. Device according to claim 5, wherein the device includes at least a test station for testing the film sections and/or the packaging products.

11. Device according to claim 5, wherein the device includes at least a unloading station for unloading faultless or defective packaging products.

12. Device according to claim 5, wherein the device includes at least a unloading station for unloading edge trimmings of the film sections remaining in the fixing devices after the packaging products have been cut out.

13. Device according to claim 5, wherein the transport device comprises at least one endless conveyor means to which the fixing means are connected.

14. Device according to claim 5, wherein the fixing means are configured to be impressed into the film sections.

15. Device according to claim 5, wherein the fixing means are configured to pierce the film sections.
